(19) United States
(12) Patent Application Publication
(10) Pub. No.: US 2021/0067290 A1
(43) Pub. Date: Mar. 4, 2021

(54) SIDELINK COMMUNICATIONS WITH TWO-STAGE SIDELINK CONTROL INFORMATION

(71) Applicant: MEDIATEK SINGAPORE PTE. LTD., Singapore (SG)

(72) Inventors: Tao Chen, Beijing (CN); Zhixun Tang, Beijing (CN); Min Lei, Beijing (CN); Zhen Zou, Beijing (CN); Xuanbo Shao, Beijing (CN)

(73) Assignee: MEDIATEK SINGAPORE PTE. LTD., Singapore (SG)

(21) Appl. No.: 17/000,936

(22) Filed: Aug. 24, 2020

Related U.S. Application Data
(63) Continuation of application No. PCT/CN2019/102555, filed on Aug. 26, 2019.

(30) Foreign Application Priority Data
Aug. 17, 2020 (CN) 202010825139.5

(51) Int. Cl. H04L 5/00; H04W 72/04; H04W 4/40; H04B 7/06; H04W 24/08; H04W 72/08; H04L 12/24

(52) U.S. Cl. CPC H04L 5/0048; H04W 72/044; H04W 4/40; H04L 27/2607; H04W 24/08; H04W 72/085; H04L 41/0806; H04B 7/0626

(57) ABSTRACT

A method of sidelink transmission with two-stage sidelink control information (SCI) can include transmitting a physical sidelink control channel (PSCCH) including a 1st-stage sidelink control information (SCI) over a sidelink from a transmission user equipment (Tx UE) to a reception user equipment (Rx UE), and transmitting a physical sidelink shared channel (PSSCH) that is associated with the PSCCH and multiplexed with a demodulation reference signal (DMRS). The 1st-stage SCI indicates a first PSSCH DMRS pattern of the DMRS multiplexed with the PSSCH.

### INCORPORATION BY REFERENCE

This present application claims the benefit of Chinese Patent Application No. 202010825139.5, “Sidelink Communications with Two-Stage Sidelink Control Information” filed on Aug. 17, 2020, which claims benefit of International Patent Application No. PCT/CN2019/102555, “Physical Channels for SL Communication” filed on Aug. 26, 2019. The prior applications are incorporated herein by reference in their entirety.

### TECHNICAL FIELD

The present disclosure relates to wireless communications, and specifically relates to sidelink communications.

### BACKGROUND

Cellular based vehicle-to-everything (V2X) (e.g., LTE V2X or NR V2X) is a radio access technology developed by the 3rd Generation Partnership Project (3GPP) to support advanced vehicular applications. In V2X, a direct radio link (referred to as a sidelink) can be established between two vehicles. The sidelink can operate under the control of a cellular system (e.g., radio resource allocation being controlled by a base station) when the vehicles are within the coverage of the cellular system. Or, the sidelink can operate independently when no cellular system is present.

### SUMMARY

Aspects of the disclosure provide a method of sidelink transmission with two-stage sidelink control information (SCI). The method can include transmitting a physical sidelink control channel (PSCCH) including a 1st-stage sidelink control information (SCI) over a sidelink from a transmission user equipment (Tx UE) to a reception user equipment (Rx UE), and transmitting a physical sidelink shared channel (PSSCH) that is associated with the PSCCH and multiplexed with a demodulation reference signal (DMRS). The 1st-stage SCI indicates a first PSSCH DMRS pattern of the DMRS multiplexed with the PSSCH.

In an embodiment a configuration of one or more PSSCH DMRS patterns associated with a resource pool is received. The 1st-stage SCI indicates one of the one or more PSSCH DMRS patterns as the first PSSCH DMRS pattern. In an embodiment, the first PSSCH DMRS pattern is determined from the one or more PSSCH DMRS patterns based on feedback information on a channel condition of the sidelink from the Rx UE or a preferred DMRS pattern. In an embodiment, a 2nd-stage SCI carried by a sequence-based signal is transmitted. In an embodiment, a 2nd-stage SCI carried on the DMRS multiplexed with the PSSCH is transmitted.

In an embodiment, the PSSCH includes channel state information (CSI) of a sidelink from the Rx UE to the Tx UE. In an embodiment, the PSSCH includes a 2nd-stage SCI carrying CSI of a sidelink from the Rx UE to the Tx UE.

In an embodiment, a channel busy ratio (CBR) measurement is performed over resources defined by a resource pool. Resources for physical sidelink feedback channel (PSFCH) are excluded for the CBR measurement. In an embodiment, the Tx UE transmits a sidelink primary synchronization signal (S-PSS) that is an M-sequence generated using a polynomial of x\hat{ }7+x\hat{ }4+1 and a cyclic shift of 22 or 65.

Aspects of the disclosure provide an apparatus comprising circuitry. The circuitry can be configured to transmit a PSCCH including a 1st-stage SCI over a sidelink from a Tx UE to a Rx UE, and transmit a PSSCH that is associated with the PSCCH and multiplexed with a DMRS. The 1st-stage SCI indicates a first PSSCH DMRS pattern of the DMRS multiplexed with the PSSCH.

Aspects of the disclosure further provide a non-transitory computer-readable medium storing instructions that, when executed by a processor, causing the processor to perform the method of sidelink transmission with two-stage SCI.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication system 100 according to an embodiment of the disclosure.

FIG. 2 shows a resource pool 200 configured for sidelink communications according to an embodiment of the disclosure.

FIG. 3 shows a sidelink transmission 300 with a two-stage sidelink control information (SCI) according to an embodiment of the disclosure.

FIG. 4 shows another sidelink transmission 400 with a two-stage SCI according to an embodiment of the disclosure.

FIGS. 5-6 show different DMRS patterns in time domain according to an embodiment of the disclosure.

FIG. 7 shows a sidelink synchronization signal block (S-SSB) 700 according to an embodiment of the disclosure.

FIG. 8 shows three S-SSB structures (Options 1, 2, and 3) according to an embodiment of the disclosure.

FIG. 9 shows a process 900 of sidelink transmission with two-stage SCI according to an embodiment of the disclosure.

FIG. 10 shows an apparatus 1000 according to embodiments of the disclosure.

### DETAILED DESCRIPTION OF EMBODIMENTS

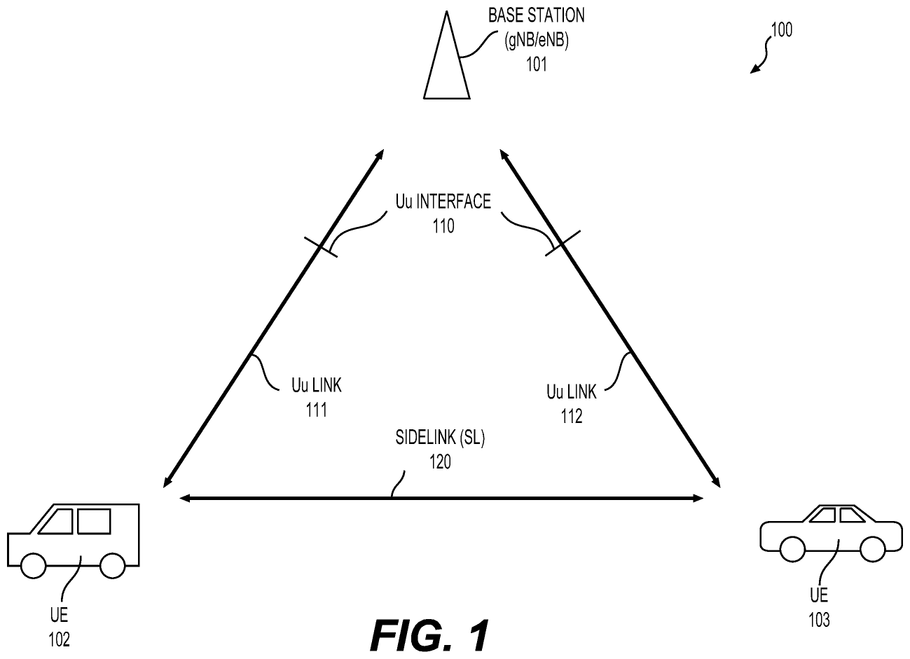

FIG. 1 shows a wireless communication system 100 according to an embodiment of the disclosure. The system 100 can include a base station (BS) 101, a first user equipment (UE) 102, and a second UE 103. The BS 101 can be an implementation of a gNB specified in the 3rd Generation Partnership Project (3GPP) New Radio (NR) standards, or can be an implementation of an eNB specified in 3GPP Long Term Evolution (LTE) standards. Accordingly, the BS 101 can communicate with the UE 102 or 103 via a radio air interface 110 (referred to as a Uu interface 110) according to respective wireless communication protocols. In other examples, the BS 101 may implement other types of standardized or non-standardized radio access technologies, and communicate with the UE 102 or 103 according to the respective radio access technologies. The UE 102 or 103 can be a vehicle, a computer, a mobile phone, a roadside unit, and the like.

The UEs 102 and 103 can communicate with each other based on vehicle-to-everything (V2X) technologies, for example, as specified in 3GPP standards. A direct radio link 120, referred to as a sidelink (SL), can be established between the UEs 102 and 103. The sidelink 120 can be either a sidelink from the UE 102 to the UE 103, or a sidelink from the UE 103 to the UE 102. The UE 102 can use a same spectrum for both uplink transmissions over a Uu link 111 and sidelink transmissions over the sidelink 120. Similarly, the UE 103 can use a same spectrum for both uplink transmissions over a Uu link 112 and SL transmissions over the sidelink 120. In addition, allocation of radio resources over the sidelink 120 can be controlled by the BS 101.

Different from the FIG. 1 example (in-coverage scenario) where the UEs 102 and 103 performing sidelink communications are under network coverage (the coverage of a cell of the BS 101), in other examples, UEs performing sidelink communications can be outside of network coverage. For example, a sidelink can be established between two UEs both of which are located outside of network coverage (out-of-coverage scenario), or one of which is located outside of network coverage (partial-coverage scenario).

In some examples, a group of UEs (such as the UEs 102 and 103 and other UEs (not shown)) in a local area may communicate with each other using sidelinks under or without control of a base station. Each UE in the group may periodically or aperiodically transmits messages to neighboring UEs. In addition, the respective transmissions can be of a type of unicast, groupcast, or broadcast. For example, hybrid automatic repeat request (HARD) and link adaptation mechanisms can be employed to support unicast or groupcast between a transmission (Tx) UE and a reception UE(s).

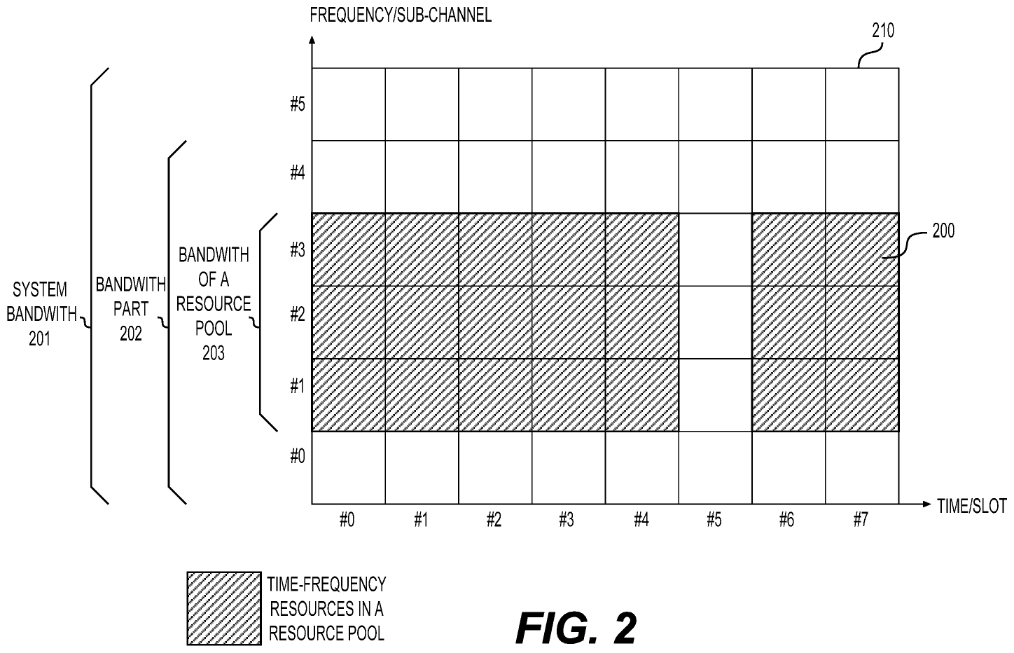

FIG. 2 shows an example of a resource pool 200 configured for sidelink communications according to an embodiment of the disclosure. For example, the resource pool 200 can be configured to the UE 102 from the BS 101, or can be pre-configured to the UE 102 (e.g., a resource pool configuration is stored in a universal integrated circuit card (UICC) of the UE 102). The resource pool 200 can be defined over a time-frequency (slot/sub-channel) resource grid 210. Radio resources for transmission of physical channels (e.g., physical sidelink control channel (PSCCH), physical sidelink shared channel (PSSCH), and the like) from the UE 102 on the sidelink 120 can be allocated based on the resource pool 200.

As shown, a system bandwidth 201 of the UE 102 can include sub-channels #0-#5. Each sub-channel may include a number of physical resource blocks (PRBs, or RBs) (e.g., 5, 10, or 20 PRBs). The resource pool 200 can include a set of consecutive (or non-consecutive) sub-channels #1-#3 in frequency domain. If the UE 102 operates in a bandwidth part (BWP) 202, a bandwidth 203 of the resource pool 200 can be configured to be within the BWP 202. In time domain, the resource pool 200 can include a number of slots (e.g., slots #0-#4 and #6-#7) that can be consecutive or non-consecutive in different examples.

Resource pools can be (pre-)configured to the UE 102 separately from the transmission perspective (Tx pools) and the reception perspective (Rx pools). Accordingly, the UE 102 can monitor for PSCCHs, and hence receive respective PSSCH transmissions from other UEs in a Rx pool while performing transmissions in a Tx pool.

In an embodiment, within each of the slots of the resource pool 200, there can be from 7 to 14 of the symbols reserved for sidelink operation, of which PSSCH can be transmitted in 5 to 12 symbols, respectively. The remaining sidelink symbols in each slot (not used for PSSCH transmission) can transmit physical sidelink feedback channel (PSFCH), automatic gain control (AGC) symbol(s), guard period (GP) symbol(s), or uplink or downlink symbols.

In an embodiment, two resource allocation modes (Mode 1 and Mode 2) can be used for allocating radio resources for PSCCH and PSSCH transmissions over a sidelink. In Mode 1, the BS 101 performs the function of resource scheduling. For example, the BS 101 can provide dynamic grants of sidelink resources, or semi-statically configured grants of periodic sidelink resources (referred to as sidelink configured grants) to the UE 102 for sidelink communications over the sidelink 120.

A dynamic sidelink grant can be provided in a downlink control information (DCI), and schedule resources for an initial transmission of a transport block, and optionally, retransmissions of the same transport block. The retransmissions can be blindly repeated transmissions, or can be retransmissions in response to a HARQ feedback. In one example, resources for each transmission or retransmission can be spanned over one or more sub-channels but limited within one slot in the sidelink resource pool 200.

For a sidelink configured grant, the scheduled resources can be a set of sidelink resources recurring with a periodicity to accommodate periodically transmitted messages. Two types of configured grant are defined in an example. The Type 1 configured grant can be configured once (e.g., by radio resource control (RRC) signaling) and used by the UE 102 immediately until being released by RRC signaling. The Type 2 configured grant can be configured once. Activation or deactivation signaling via a DCI can be employed to start or terminate usage of the Type 2 configured grant. Multiple configured grants can be configured to allow provision for different services, traffic types, etc.

In an embodiment, modulation and coding scheme (MCS) information for dynamic and configured grants can optionally be provided or constrained by RRC signaling instead of traditional DCI. RRC can configure an exact MCS, or a range of MCS. In an example, RRC does not provide the exact MCS, a transmitting UE can select an appropriate MCS itself based on the knowledge of a transport block (TB) to be transmitted and, potentially, sidelink radio conditions.

When the UE 102 is in an out-of-coverage status, or the UE 102 is in an in-coverage status but instructed by the BS 101, Mode 2 can be employed for resource scheduling (resource allocation). In Mode 2, the UE 102 can autonomously select resources for sidelink transmissions based on a sensing procedure. For example, the UE 102 can sense, within a (pre-) configured resource pool, which resources are not in use by other UEs with higher-priority traffic, and select an appropriate amount of resources for sidelink initial transmissions and, optionally, retransmissions. In the selected such resources, the UE 102 can transmit and re-transmit a certain number of times.

For example, the UE 102 can reserve resources to be used for a number of blind (re-)transmissions or HARQ-feedback-based (re-)transmissions of a transport block. The UE 102 can also reserve resources to be used for an initial transmission of a later transport block. The reserved resources can be indicated in an SCI scheduling a transmission of a transport block. Alternatively, an initial transmission of a transport block can be performed after sensing and resource selection, but without a reservation.

SCIs (e.g., 1st-stage SCI) transmitted by UEs on PSCCH indicate selected (or reserved) time-frequency resources in which the respective UE will transmit a PSSCH. The indicated time-frequency resources can be allocated with either Mode 1 or Mode 2. These SCI transmissions can be used by sensing UEs to maintain a record of which resources have been reserved by other UEs in the recent past. When a resource selection is triggered (e.g. by traffic arrival or a resource re-selection trigger), the UE 102 (while performing sensing) considers a sensing window which starts a (pre-)configured time in the past and finishes shortly before the trigger time. The sensing UE 102 also measures, for example, the PSSCH reference signal received power (RSRP) over selected or reserved resources in the slots of the sensing window. The measurements can indicates a level of interference which would be experienced if the sensing UE 102 were to transmit in the selected or reserved resources.

The sensing UE 102 can then select resources for transmission(s) or retransmission(s) from within a resource selection window. For example, the resource selection window starts after the trigger for transmission, and cannot be longer than a remaining latency budget of a to-be-transmitted transport block. Based on the SCIs from the other UEs and the measurements as described above, selected or reserved resources by the other UEs in the selection window with PSSCH-RSRP above a threshold are excluded from being candidates by the sensing UE 102. The threshold can be set according to priorities of the traffic (e.g., priorities associated with respective transport blocks) of the sensing UEs and the other transmitting UEs. Thus, a higher priority transmission from the sensing UE 102 can occupy resources which are reserved by a transmitting UE with sufficiently low PSSCH-RSRP and sufficiently lower-priority traffic.

In an example, from the set of resources in the selection window which have not been excluded, the sensing UE can identify a certain percentage (e.g., 20%) of the available resources within the window as candidate resources. The UE 102 may select from the candidate resources for a number of initial- or re-transmissions of the to-be-transmitted transport block, for example, in a random way.

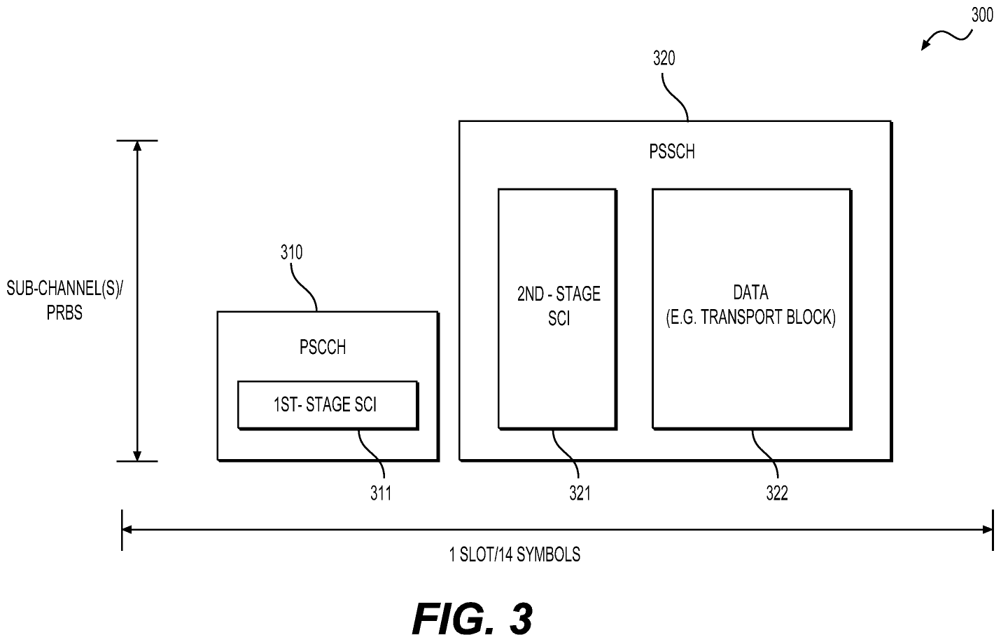

FIG. 3 shows an example of a sidelink transmission 300 with a two-stage SCI according to an embodiment of the disclosure. In the sidelink transmission 300, a PSCCH 310 and a PSSCH 320 associated with the PSCCH 310 can be generated and transmitted from the UE 102. The PSCCH 310 can carry a 1st-stage SCI 311, while the PSSCH 320 can carry a 2nd-stage SCI 321 and data 322 (e.g., data of a transport block and optionally other type of data). For example, the 1st-stage or 2nd-stage SCI can be generated and processed (e.g., channel coding, modulation, precoding, and the like) at a physical layer before being mapped to resource elements (REs) in the respective physical channels (e.g., PSCCH 310 or PSSCH 320). The transport block can be received from a higher layer (e.g., medium access control (MAC) layer) and processed (e.g., channel coding, modulation, precoding, and the like) at the physical layer before being mapped to REs in the respective PSSCH 320.

In one example, the UE 102 can be configured to perform each transmission or retransmission of a transport block or other type of data within a slot in time domain. Accordingly, as shown in FIG. 3, resources for transmitting PSCCH 310 and PSSCH 320 can be selected in a Tx resource pool within a slot in time domain and one or more sub-channels in frequency domain. In an example, a slot may include 14 symbols (e.g., orthogonal frequency division multiplexing (OFDM) symbols) but may have different duration depending on respective sub-carrier spacings. For example, corresponding to different sub-carrier spacings 15 kHz, 30 kHz, or 60 kHz, a 1-ms subframe may include 1, 2, or 4 slots each including 14 symbols.

In other examples, the PSCCH 310 and the PSSCH 320 may be transmitted in different slots. Accordingly, resources for transmitting PSCCH 310 and PSSCH 320 can be selected from different slots in a Tx resource pool.

In FIG. 3, the PSCCH 310 and the PSSCH 320 are shown to be time-division multiplexed (TDMed). However, in other examples, the PSCCH 310 and the PSSCH 320 can be frequency-division multiplexed (FDMed). For example, within the bandwidth of the assigned sub-channels in FIG. 3, the resources above the PSCCH 310 can also be assigned for transmission of the PSSCH 320.

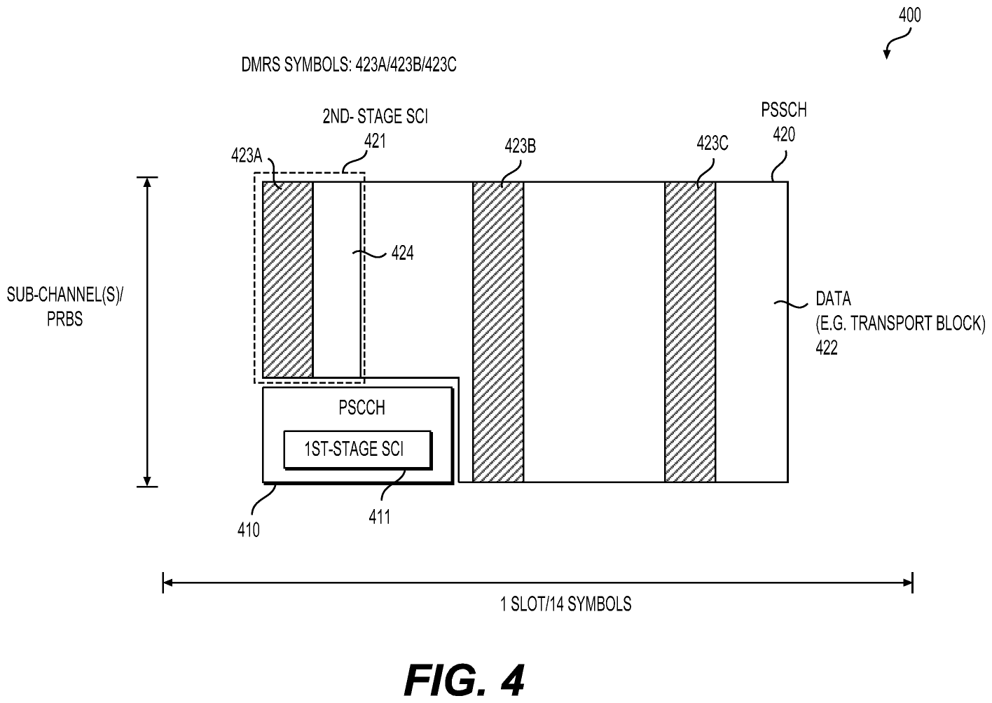

FIG. 4 shows another example of a sidelink transmission 400 with a two-stage SCI according to an embodiment of the disclosure. In the sidelink transmission 400, a PSCCH 410 and an associated PSSCH 420 can be generated and transmitted from the UE 102. The PSCCH 410 can carry a 1st-stage SCI 411, while the PSSCH 420 can carry a 2nd-stage SCI 421 and data 422 (e.g., data of a transport block). Similar to the FIG. 3 example, time-frequency resources for transmitting PSCCH 410 and the PSSCH 420 can be selected to be within a slot in time domain and one or more sub-channels in frequency domain in a Tx resource pool. Different from the FIG. 3 example, the PSSCH 420 is TDMed and FDMed with the PSCCH 410.

In addition, as shown in FIG. 4, the PSSCH 420 can be multiplexed with a demodulation reference signal (DMRS) mapped in several symbols 423A, 423B, and 423C (referred to as DMRS symbols). In an example, PRBs in the DMRS symbols can each include REs in which the DMRS is mapped. The REs carrying the DMRS in one DMRS symbol may form a comb-alike structure in some examples. REs without carrying the DMRS in one DMRS symbol can be used to carry the 2nd-stage SCI 421 or the data 422.

Two-stage SCI is used for sidelink transmission in the examples of FIG. 3 and FIG. 4. The corresponding sidelink transmissions 300 or 400 can be of a type of unicast, groupcast, or broadcast. During the transmissions 300/400, the 1st-stage SCI 311/411 can be employed for sensing purpose and carry information related to channel sensing. The 1st-stage SCI 311/411 can also carry information of resource allocation of the respective PSSCH 320/420.

The 2nd-stage SCI 321/421 can carry information (e.g., new data indicator, and redundancy version (RV)) needed for identifying and decoding the data 322/422, controlling HARQ procedures, triggering channel state information (CSI) feedback, and the like. The 2nd-stage SCI 321/421 can be transmitted with link adaptation based on channel conditions between the Tx UE 102 and the target UEs. For example, a high coding rate may be used for transmitting the 2nd-stage SCI 321/421 to improve spectra efficiency. The high coding rate can be determined based on a signal to noise ratio (SNR) level of channels between the Tx UE 102 and the target UEs. In an example, polar code is used for channel coding of the 2nd-stage SCI 321/421.

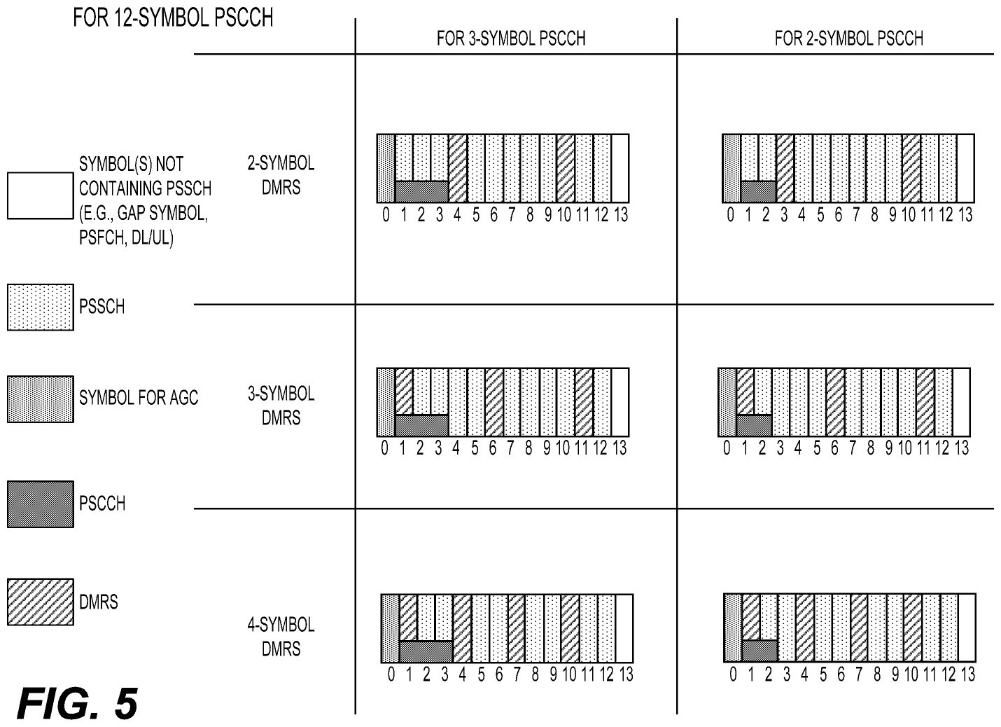

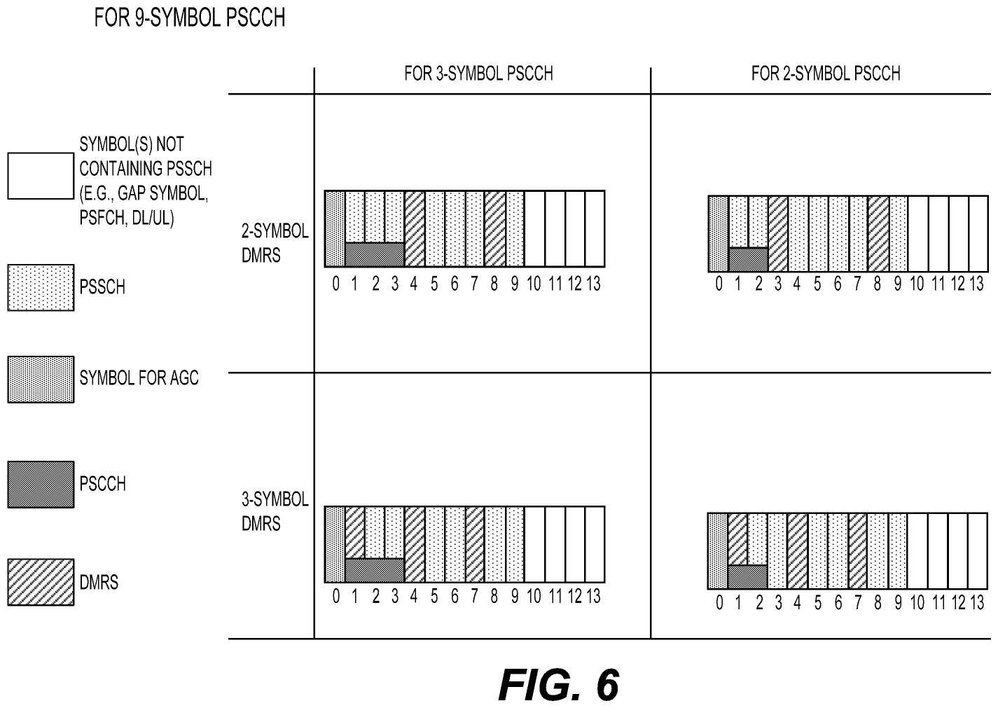

FIGS. 5-6 show different DMRS patterns in time domain according to an embodiment of the disclosure. FIG. 5 shows 2-symbol, 3-symbol, and 4-symbol DMRS patterns in time domain over a 12-symbol PSSCH in a 14-symbol slot. For different PSCCH symbol numbers (3 symbols or 2 symbols), the respective DMRS patterns can be different. FIG. 6 shows 2-symbol and 3-symbol DMRS patterns in time domain over a 9-symbol PSSCH in a 14-symbol slot. Similarly, for different PSCCH symbol numbers (3 symbols or 2 symbols), the respective DMRS patterns can be different.

As shown in FIGS. 5-6, in addition to the PSSCH symbols (where the PSSCH is multiplexed with the PSCCH and the DMRS), each of the 14-symbol slots can further include an AGC symbol at the beginning of each slot, and gap symbol(s) (or guard period (GP) symbols), PSFCH symbols, and symbols for uplink or downlink transmissions at the end of each slot. While the PSSCH has 11 or 9 symbols in FIGS. 5-6, a PSSCH in a 14-symbol slot may occupy symbols in a range from 5 to 12 symbols in other examples.

In an embodiment, a set of DMRS patterns in time domain can be defined and (pre-)configured to a UE (e.g., the UE 102 or 103). For example, the DMRS patterns can be configured for a resource pool. Corresponding to a slot in the resource pool, for different number of PSCCH symbols, PSSCH symbols, and DMRS symbols, different distribution of DMRS symbols in the slot can be defined to form different DMRS patterns in time domain. For example, those DMRS patterns can be configured to the UE 102 from the BS 101 by RRC signaling or broadcasting of a system information block (SIB). Or, those DMRS patterns can be preconfigured and stored in a local memory of the UE 102 such as in a universal integrated circuit card (UICC).

For a sidelink transmission over the sidelink 120 to the UE 103, the UE 102 as a Tx UE can dynamically select a DMRS pattern from the set of (pre-)configured DMRS patterns. For example, based on a current channel condition of the sidelink 120 (e.g., different Doppler spread for different relative speed between the UE 102 and the UE 103) or a preferred DMRS pattern from Rx UE, the number of DMRS symbols (2, 3 or 4 symbols) can be determined. Numbers of PSCCH symbols and PSSCH symbols can also be configured to UE 102 previously, or dynamically determined at the UE 102. Based on those information, a DMRS pattern can be determined.

In addition, during the sidelink transmission, which DMRS pattern (which of the 2-symbol, 3-symbol, or 4-symbol DMRS pattern) is used can be indicated in the SCI (e.g., the 1st-stage SCI) scheduling the sidelink transmission. At the Rx UE 103, by decoding the 1st-stage SCI, and in combination with other information (e.g., numbers of PSSCH and PSCCH symbols), the UE 103 can determine the DMRS pattern in time domain used for the sidelink transmission. The UE 103 can then perform channel estimation or other measurements based on the respective DMRS symbols. For example, the channel estimation result can be used for decoding the PSSCH (e.g., decoding a 2nd-stage SCI or a transport block).

The above method of dynamically indicating which DMRS pattern is used in the two-stage SCI can be used in unicast-, groupcast-, or broadcast-type sidelink transmissions.

In an embodiment, the UE 102 as a Tx UE can select a DMRS pattern for a sidelink transmission based on measurements and/or the preference provided from the UE 103 as a Rx UE. For example, Mode 2 resource allocation is employed for the sidelink transmission. For different relative speeds between the UE 102 and the UE 103, different DMRS patterns in time domain can be used. For low-speed scenarios, a lower time density of DMRS (e.g., 2-symbol DMRS) can be used, while for high-speed scenarios, a higher time density of DMRS (e.g. 4-symbol DMRS) to track fast changes in a high-speed channel can be used. The Tx UE itself cannot determine the relative speed. To facilitate the selection of the DMRS pattern, the Rx UE can provide feedback information on channel conditions to the Rx UE. For example, the information on channel conditions can include Doppler spread and/or delay spread related information and/or the preferred DMRS pattern by Rx UE. Based on those information, the Tx UE can suitably determine the DMRS patter for the sidelink transmission.

When Mode 1 resource allocation scheme is used for a sidelink transmission, the Tx UE may forward the channel condition information received from the Rx UE to a BS. The BS can accordingly determine a DMRS pattern for the sidelink transmission, and inform the Tx UE for example by signaling of a DCI. In case no feedback information is available at the Tx UE (e.g., groupcast or broadcast without feedbacks), a default DMRS pattern (number of DMRS symbols) can be selected by the Tx UE in an example. The Tx UE can then indicate the respective DMRS pattern in a 1st-stage SCI.

In an embodiment, the UE 102 employs two-stage SCI for sidelink transmissions, and includes feedback information in the 2nd-stage SCI. The feedback information can include CSI information, HARQ feedback information (e.g., ACK or NACK), and the like. For example, the UE 102 and UE 103 can communicate with each other over the sidelink 120. The UE 103 may signal a request to the UE 102 for feedback of CSI. To facilitate measurement of the CSI, the UE 103 may transmit CSI reference signal (CSI-RS). The UE 102 may accordingly perform CSI measurement based on the CSI-RS, and feedback the CSI by including the CSI information in a 2nd-stage SCI transmitted to the UE 103. Similarly, corresponding to one or more sidelink transmissions from the UE 103, the UE 102 may include HARQ feedback information in a 2nd-stage SCI transmitted to the UE 103.

In different examples, 2nd-stage SCI carrying feedback information can be transmitted with or without an associated transport block. For example, at a certain time, the UE 102 may not have data (e.g., a transport block) to be transmitted. In such a scenario, the UE 102 can transmit a standalone 2nd-stage SCI without companion data in order to provide the feedback with a shorter delay.

In an example, CSI measurement information is carried in a MAC control element (CE) of a transport block for feedback to a UE requesting CSI. In such a solution, decoding of the transport block at the UE requesting SCI may fail, and multiple HARQ-based retransmissions may subsequently take place, which leads to a delay of CSI feedback. In addition, if no data is to be transmitted, there is no way to feedback the CSI, which also cause a delay. The delay may cause the CSI to be useless for indicating rapidly changed channel conditions. Compared with the MAC CE based solution, the method of using physical layer 2nd-stage SCI carrying feedback information (e.g., CSI) can be more advantageous in terms of flexibility and delay.

In an embodiment, the UE 102 employs sequence-based 2nd-stage SCI for sidelink transmissions. For example, a 2nd-stage SCI can take a form of a payload (bits) when a size of the 2nd-stage SCI is relatively large (e.g., dozens of bits). In certain scenarios, a 2nd-stage SCI may have a small number of bits (e.g., several bits). As an example, when configured grant in Type 1 is used, resource allocation information (e.g., period, size, MCS, and the like) for sidelink transmissions can be configured to a pair of Tx UE and Rx UE in advance. As a result, resource allocation information may not be provided in the 2nd-stage SCI. The 2nd-stage SCI size can thus be reduced. When the size of a 2nd-stage SCI is small, the 2nd-stage SCI can take a form of a sequence signal to save overhead (dedicated REs) for 2nd-stage SCI.

Particularly, in the embodiment, a sequence of a DMRS multiplexed with a PSSCH can be used as the sequence to carry information of the respective 2nd-stage SCI. For example, different DMRS sequences can be used for representing the bits of different 2nd-stage SCI. Thus, an overhead for transmitting 2nd-stage SCI can be avoided or reduced.

In an example, when the sequence-based 2nd-stage SCI is used by a Tx UE, a corresponding Rx UE can first try to decode (or determine) the sequence to obtain respective 2nd-stage SCI. For example, a correlation based method may be used, and previously configured candidate DMRS sequences may be ranked based on calculated correlation values. Then, the most probable DMRS sequence can be identified and a respective 2nd-stage SCI can be obtained. Data (e.g., a coded transport block) can then be decoded based on the 2nd-stage SCI. A cyclic redundancy check (CRC) of the transport block can be verified. If not successful, it is possible that the DMRS sequence (the 2nd-stage SCI) is not the correct one. The Rx UE may try the second probable DMRS sequence similarly to continue the decoding of the data.

In an embodiment, a sensing UE performs channel busy ratio (CBR) measurement for sidelink congestion control purpose. As an example, a CBR can be defined as a ratio between the time a radio channel is sensed as busy and a total observation time (e.g., 100 ms). The CBR can be a measure for a channel load perceived by a sensing UE, and depends on a number of neighboring UEs in a transmission (or reception) range of the sensing UE and individual message generation rates of the neighboring UEs. The sensing UE can adjust transmission related parameters to adapt to a congestion level reflected by the CBR. In different examples, CBR may be defined in different ways. For example, received signal strength indicator (RSSI) can be measured over symbols used for sidelink operations to indicate a congestion level. When the RSSI measured over a resource (e.g., a slot) is above a threshold, it can be determined that a traffic over the resource is busy.

In the embodiment, the sensing UE performs the CBR measurement over a resource pool, however, PSFCH resources are excluded from the CBR measurement. For example, for PSFCH transmission, a period of N=1, 2, or 4 slots can be defined, and PSFCH transmission can take place for every N slot. Under certain configuration (e.g., blind retransmission), no PSFCH is transmitted. Thus, occurrence of PSFCH transmission may not be related with a congestion status. Thus, PSFCH resources can be excluded from the CBR measurement.

For example, a certain number of PSSCH symbols (e.g., 5-12) within a slot can be configured to a resource pool. The sensing UE may detect PSCCH transmissions over a subset of slots belonging the resource pool and perform the CBR measurement over the PSSCH symbols within detected slots (PSCCH has been detected). In each slot of the FIGS. 5-6 examples, the symbols for PSFCH, GP, and uplink/downlink transmission can be excluded from the CBR measurement. The AGC symbol may or may not be excluded from the CBR measurement in different examples.

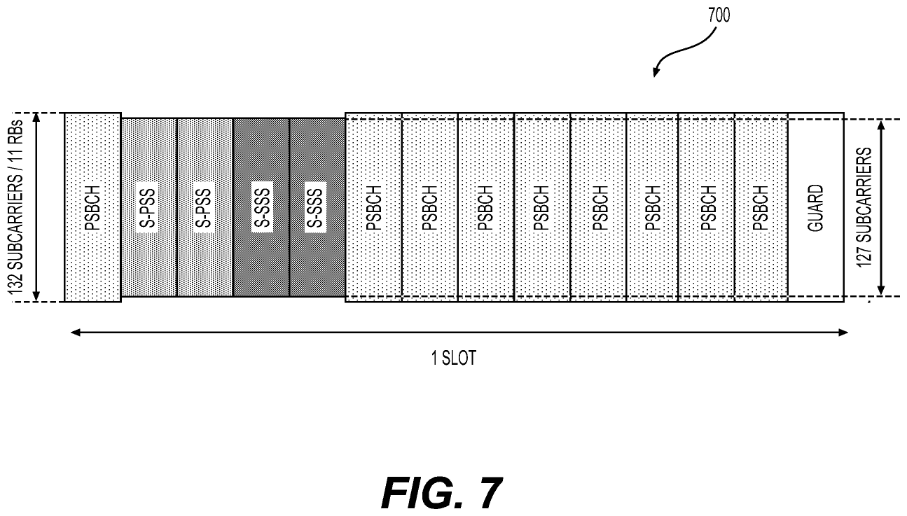

FIG. 7 shows a sidelink synchronization signal block (S-SSB) 700 according to an embodiment of the disclosure. The S-SSB 700 can be carried in a slot having 14 symbols. The S-SSB 700 can include two symbols of repeated sidelink primary synchronization signal (S-PSS) at the second and third symbols of the slot, and two symbols of repeated sidelink secondary synchronization signal (S-SSS) at the fourth and fifth symbols of the slot. The S-SSB 700 can further include a physical sidelink broadcast channel (PSBCH) and a DMRS multiplexed with the PSBCH in the remaining symbols (except a GP symbol at the end of the slot). The PSBCH can occupy 132 subcarriers (11 RBs) (that is referred to as an S-SSB bandwidth), while the S-PSS and S-SSS can each occupy 127 subcarriers of the S-SSB bandwidth.

The S-PSS and S-SSS can use the same types of sequence as NR PSS and SSS for downlink of the Uu interface, respectively, i.e. an M-sequence and a Gold sequence. In an example, the S-PSS sequence can be generated use the same characteristic polynomial (e.g., x⁷+x⁴+1) as the NR PSS but with different cyclic shifts (e.g., 22 or 65). For example, for NR PSS sequence generation, the candidate cyclic shifts are 0, 46, or 86 selected from 127 possible values from 0 to 126. For S-PSS sequence generation, the candidate cyclic shifts can be determined as the following two values: (i) 43−floor(43−0)/2)=22 (or 43-ceiling((43−0)/2)=21), and (ii) 43+floor((86−43)/2)=65 (or 43+ceiling((86−43)/2)=64). In principle, the selected S-PSS sequence is at the middle between two neighboring NR PSS sequences (e.g., 21/22 at the middle between 0 and 43, while 65/64 at the middle between 43 and 86). In this way, an S-PSS can have a small correlation with NR PSS, and consequently an S-SSB can be better distinguished from NR SSB over the Uu interface.

As an example, an S-PSS can be generated according to the following expressions:

d_{SL_PSS}(n)=1−2x(m)

m=(n+43N_{ID}⁽²⁾+22)mod127

0≤n<127

or

d_{S_PSS}(n)=1−2x(m)

m=(n+43N_{ID}⁽²⁾+21)mod127

0≤n<127

where corresponding to the polynomial x⁷+x⁴+1, the x(m) can be derived according to,

x(i+7)=(x(i+4)+x(i))mod 2

with initial values of [x(6) x(5) x(4) x(3) x(2) x(1) x(0)] =[1 1 1 0 1 1 0], and N_{ID}⁽²⁾ may takes one of the values 0 or 1 in an example.

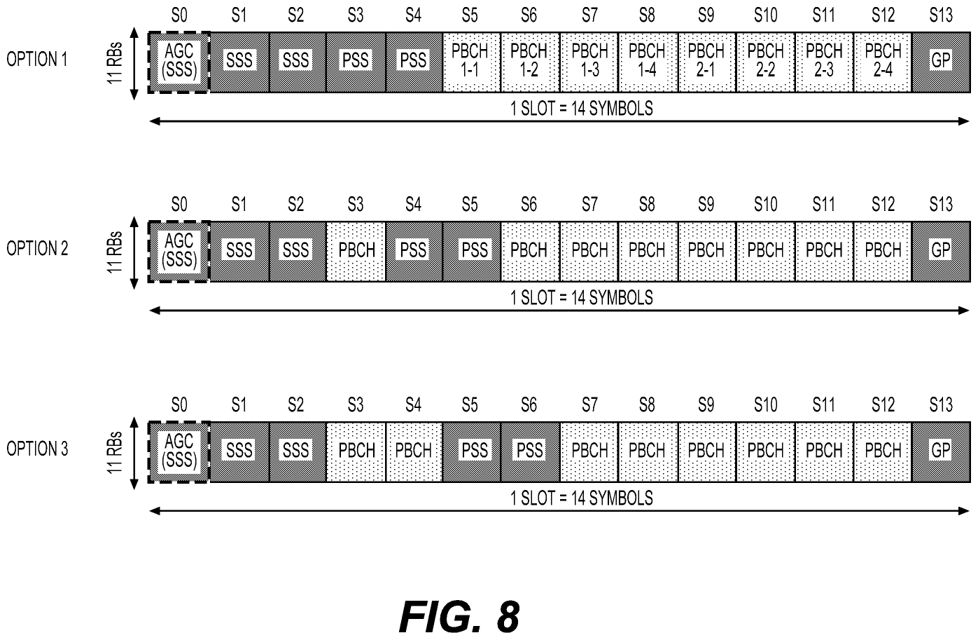

FIG. 8 shows three S-SSB structures (Options 1, 2, and 3) according to an embodiment of the disclosure. Each slot containing the S-SSB structures can include an AGC symbol, a GP symbol, two S-SSS symbols (shown as SSS symbols), two S-PSS symbols (shown as PSS symbols), and 8 PSBCH symbols (shown as physical broadcast channel (PBCH) symbols). In the three options, the S-PSS symbols are arranged in different locations within respective slots.

For example, as shown in FIG. 8, the arrangement can be SSS symbols at first and then followed by PSS symbols with or without some PBCH symbols forming a gap. The gap can be used to reduce the impact of transient time due to a power change. Additionally, for PBCH, the PBCH symbols can be repeated for transmission. For another example (not shown), the structure can be SSS-SSS-PBCH-PBCH-PBCH-PBCH-PSS-PSS-PBCH-PBCH-PBCH-PBCH, or PSS-PSS-PBCH-PBCH-PBCH-PBCH-SSS-SSS-PBCH-PBCH-PBCH-PBCH. In this example, 4 consecutive PBCH symbols are transmitted and repeated in the other 4 PBCH symbols. PSS or SSS are located between two transmissions of 4-symbol PBCH.

For S-SSB transmission, multiple periodicities can be pre-defined and (pre-) configured per resource pool, sub-channel, bandwidth part or carrier. Additionally, the different sidelink synchronization identities (SSIDs) mapping to the different sync priority level/group can be associated with the different periodicities. For example, an SSID indicating the synchronization reference UE (SyncRef UE) directly synced to global navigation satellite system (GNSS)/eNB/gNB with a higher priority can be (pre-)configured or associated with a short periodicity, e.g., 80 ms. An SSID indicating the synchronization reference UE indirectly synced to GNSS/eNB/gNB with the lower priority can be (pre-)configured or associated with a long periodicity, e.g., 160 ms.

In an embodiment, for CSI-RS confined within the SL control/data channels (e.g., over PSSCH symbols), a configuration of time/frequency location within the associated SL control/data channels can be signaled via SL RRC signaling during a unicast/groupcast connection setup phase or (pre-)configured per resource pool/bandwidth part/subchannel/carrier. The presence of CSI-RS can be indicated in an SCI (e.g., the 1st SCI of the two-stage SCI). For phase tracking reference signal (PTRS), a configuration of time/frequency location within associated SL control/data channels can be (pre-)configured per resource pool/bandwidth part/subchannel/carrier/cast type (unicast/groupcast/broadcast).

In an embodiment, CSI reports with rank indicator (RI) and/or corresponding channel quality indicator (CQI) information can be carried in SCI (e.g., the single SCI or 2nd SCI of the two-stage SCI). The inclusion of CSI reports in a single SCI can be indicated in the single SCI. In case of two-stage SCI, the inclusion of CSI reports in the 2nd SCI of two-stage SCI can be indicated in the 1st SCI of the two-stage SCI. Alternatively, whether to report CSI over PSSCH or multiplexing with PSSCH or over single SCI or over 2nd SCI of two-stage SCI can be indicated in the single SCI or the 1st SCI of two-stage SCI. Additionally, a Tx UE may indicate a rank assumption (e.g., Rank 1 and/or Rank 2) for CSI reporting in SCI. In addition, the feedback information such as HARQ ACK and/or NACK can be carried over SCI, e.g., the single SCI, 1st SCI or 2nd SCI of the two-stage SCI. The SCI may have a bit to indicate whether it is a standalone single SCI (or two-stage SCI) without the associated with data transmission.

In an embodiment, in case of two-stage SCI, a set of candidates of the time and/or frequency locations and/or payload sizes for a 2nd SCI can be defined by RRC signaling and then indicated by a 1st SCI within the defined set. Additionally, all potential candidates of the time and/or frequency locations and/or payload sizes can be (pre-)configured or defined in a table and then selected by RRC signaling for a subset of the potential candidates and finally indicated by the 1st SCI within the subset.

Alternatively, the starting time and/or frequency location of 2nd SCI can be (pre-) configured per resource pool/subchannel/bandwidth part/carrier and/or derived/determined based on a pre-defined rule. For link adaptation of the 2nd SCI, a full or partial MCS information for the data channels can be implicitly linked to a resource size or a coding rate for the 2nd SCI, which can be carried in the 1st SCI. Then another field in the 1st SCI can indicate the payload size or formats of the 2nd SCI from a set of (pre-)configurations or a subset configured by SL RRC signaling from a (pre-)configured or pre-defined set of settings. The 2nd SCI payload sizes or formats can be (pre-)configured per resource pool/sub-channels/bandwidth part/carrier or pre-defined. Accordingly, the UE can derive the total resource size based on the 2nd SCI payload size/formats and the coding rate derived from the partial/full data MCS.

Moreover, 2nd SCI without its own dedicated DMRS can share a data DMRS for channel estimation. Thus, the REs for 2nd SCI can be mapped on the available/valid REs starting from the 1st data DMRS symbol in the slot or the symbol next to the 1st data DMRS symbol (e.g., after/before 1st data DMRS with or without one or a few symbols for gap). The RE mapping order can be starting from the lowest subcarrier (or the lowest X-th subcarrier or the first subcarrier of the lowest N-th RBs) to the highest subcarrier (or the highest Y-th subcarrier or the last subcarrier of the highest M-th RBs) within the associated time/frequency region (e.g., data channel region) indicated by 1st SCI or a (pre-)configured time/frequency region (maybe across the multiple sub-channels). M can be set as N where M and N can be integer number. M and N can be same values (e.g., 0 or 1), i.e., the gap to the edge can be same. The mapping order can also be starting from the highest to the lowest subcarriers in frequency domain. In principle, the mapping for 2nd SCI is frequency first and then time domain until the end of the coded bits for mapping.

In case of multiple-input-multiple-output (MIMO) transmission, the same set of coded bits can be mapped to the multi-layers. Alternatively, the coded bits can be generated based on the multiple layers and mapped accordingly. The available REs for 2nd SCI mapping can be defined as the REs confined within the associated time/frequency region (e.g., data channel region) indicated by 1st SCI or a (pre-)configured time/frequency resource region by excluding the following one or multiple REs such as data DMRS, 1st SCI, 1st SCI DMRS, CSI-RS/PTRS, the reserved REs and/or guard REs for in-band emission (IBE) mitigation (e.g., at the edge of the data channel region). If there is no associated data channel, the available REs for 2nd SCI mapping can be defined as the REs within the (data) region indicated in 1st SCI or a (pre-) configured region.

Additionally, the mapping can depend on the multiplexing of antenna ports. For FDM multiplexing of antenna ports with no available REs in the symbol, the 2nd SCI is mapped from the symbol next to the 1st DMRS symbol. For code division multiplexing (CDM) of antenna ports, the available REs of the 1st DMRS symbol can be used for 2nd SCI mapping. Additionally, 2nd SCI can be FDMed with 1st SCI. For example, the remaining REs of the same symbols excluding 1st SCI and 1st SCI DMRS can be used for 2nd SCI RE mapping. In this case, FDMed and/or TDMed multiplexing between 1st SCI and 2nd SCI is supported. Moreover, whether the same transmission scheme or antenna ports are used for 1st SCI and data transmission can be indicated in the 1st SCI of two-stage SCI (or the single SCI) so that the channel estimation for the data channel and/or 2nd SCI can use 1st SCI DMRS and/or data DMRS.

In an embodiment, for DMRS patterns in the time and frequency domain for control and/or data channels, the DMRS patterns can be (pre-)configured per resource pool/bandwidth part/carrier/subcarrier spacing. Additionally, the symbol for the 1st DMRS can be (pre-)defined (e.g., the first symbol after the 1st SCI or a fixed position) or (pre-)configured per resource pool/bandwidth part/sub-channel/carrier to facilitate the channel estimation of the 2nd SCI occurred in the early time. In this case, only the time locations of the remaining DMRS symbols can be (pre-)configured and/or indicated by SCI.

Additionally, a set of DMRS patterns can be (pre-)configured or defined before the unicast connection setup. An SCI can further dynamically indicate which pattern is used. To facilitate the selection of the DMRS pattern, the feedback information on the channel condition, e.g., the Doppler spread and/or delay spread related information and/or the preferred DMRS pattern can be provided, e.g., from the Rx UE feedback to the Tx UE. In an example, the preferred time-frequency DMRS pattern can be indicated by the Rx UE to the Tx UE via signaling (e.g., SCI, RRC signaling, and/or the feedback channel such as PSFCH associated with/without A/N feedback).

In an example, such feedback information can be carried by the PSFCH channel. For example, the different resource including the sequences to be selected by the Rx UE for ACK and/or NACK reporting may imply the different DMRS pattern preferred for reception. Then Tx UE can derive/select a proper DMRS pattern and indicate it in the SCI or use it according to a timer. Additionally, the DMRS pattern can be fixed/pre-defined for the broadcast communications with no need of dynamic indication and only dynamically changed/indicated for the unicast/groupcast communications. In an example, the Tx UE can determine the Doppler spread and/or delay spread related information based on the reception of physical channels from the Rx UE, e.g., PSFCH/PSCCH/PSSCH channels. Accordingly, the Tx UE can set the DMRS pattern in SCI to inform the Rx UE.

In an embodiment, for CBR and/or RSSI based sensing measurements, symbols for measurements can be defined as the symbols within a slot excluding the symbols for the feedback channels (e.g., PSFCH), GP symbol(s) and the symbols reserved/used for Uu link transmission/reception.

In an embodiment, for L1-ID (source and/or dest ID) carried in SCI, the partial ID information can be carried in the 1st SCI and the remaining information can be carried in the 2nd SCI with or without CRC scrambling in 2nd SCI.

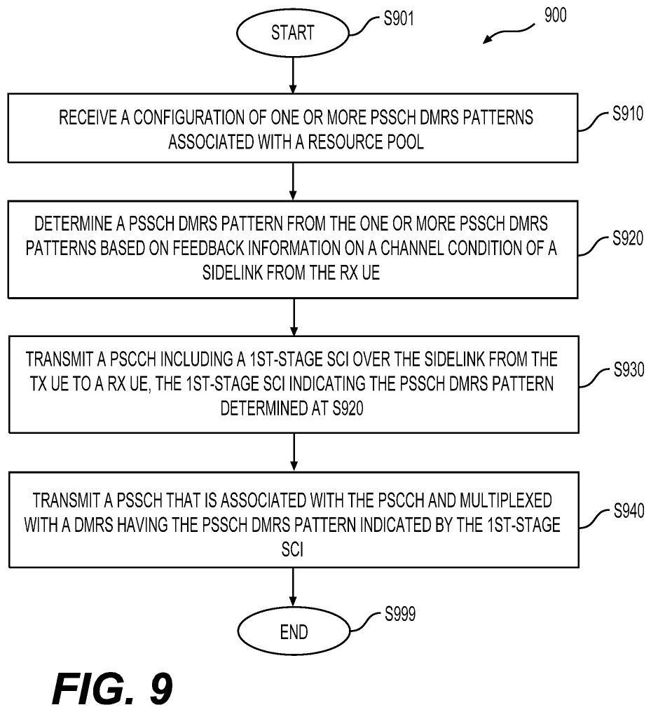

FIG. 9 shows a process 900 of sidelink transmission with two-stage SCI according to an embodiment of the disclosure. The process 900 can be performed by a Tx UE communicating with a Rx UE over a sidelink. The process 900 can start from S901, and proceed to S910. In various embodiments, some of the steps of the process 900 shown can be performed concurrently or in a different order than shown, can be substituted by other method steps, or can be omitted. Additional method steps can also be performed as desired. Aspects of the process 900 can be implemented by a wireless device, such as the UE 102 or 103 illustrated in and described with respect to the preceding figures.

At S910, a configuration of one or more PSSCH DMRS patterns associated with a resource pool can be received at the Tx UE. For example, corresponding to different number of PSSCH symbol numbers, different PSCCH symbol numbers, and different DMRS symbol numbers, different PSSCH DMRS patterns in time domain can be defined. The configuration of those PSSCH DMRS patterns can be signaled from a BS to the Tx UE, or fetched from a memory at the Tx UE.

At S920, before a sidelink transmission from the Tx UE to the Rx UE, a PSSCH DMRS pattern can be determined or selected from the one or more PSSCH DMRS patterns. The determination can be based on feedback information on a channel condition of the sidelink and/or a preferred DMRS pattern from the Rx UE. For example, the Tx UE may trigger the Rx UE to perform a measurement of the channel condition based on CSI-RS transmitted from the Tx UE and feedback the measurement results to the Tx UE. For example, the feedback information may indicate a measure of a Doppler spread Based on the feedback information, the Tx UE may determine which PSSCH DMRS pattern (e.g., 2-symbol, 3-symbol, or 4-symbol) to be used. In another example, the Rx UE provides the preferred DMRS pattern to the Tx UE.

At S930, a PSCCH including a 1st-stage SCI can be transmitted over the sidelink from the Tx UE to the Rx UE. The 1st-stage SCI can include a field indicating the PSSCH DMRS pattern (e.g., 2-symbol, 3-symbol, or 4-symbol) determined at S920.

At S940, a PSSCH associated with the PSCCH can be transmitted. The PSSCH can be multiplexed with the PSCCH in frequency domain and time domain. In addition, the PSSCH can be multiplexed with a DMRS having the PSSCH DMRS pattern as indicated by the 1st-stage SCI. The process 900 can proceed to S999, and terminate at S999.

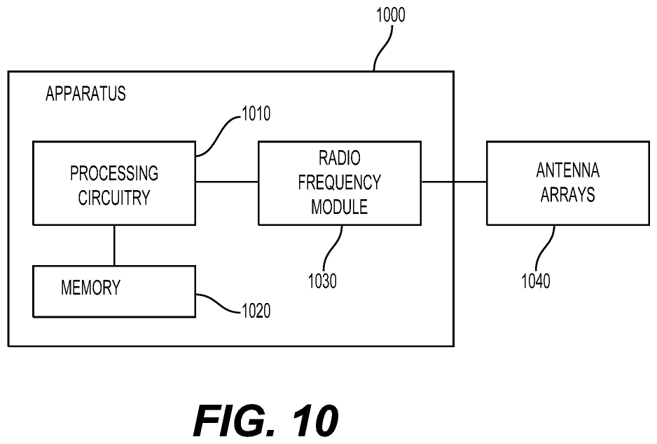

FIG. 10 shows an exemplary apparatus 1000 according to embodiments of the disclosure. The apparatus 1000 can be configured to perform various functions in accordance with one or more embodiments or examples described herein. Thus, the apparatus 1000 can provide means for implementation of mechanisms, techniques, processes, functions, components, systems described herein. For example, the apparatus 1000 can be used to implement functions of UEs or BSs in various embodiments and examples described herein. The apparatus 1000 can include a general purpose processor or specially designed circuits to implement various functions, components, or processes described herein in various embodiments. The apparatus 1000 can include processing circuitry 1010, a memory 1020, and a radio frequency (RF) module 1030.

In various examples, the processing circuitry 1010 can include circuitry configured to perform the functions and processes described herein in combination with software or without software. In various examples, the processing circuitry 1010 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1010 can be a central processing unit (CPU) configured to execute program instructions to perform various functions and processes described herein. Accordingly, the memory 1020 can be configured to store program instructions. The processing circuitry 1010, when executing the program instructions, can perform the functions and processes. The memory 1020 can further store other programs or data, such as operating systems, application programs, and the like. The memory 1020 can include non-transitory storage media, such as a read only memory (ROM), a random access memory (RAM), a flash memory, a solid state memory, a hard disk drive, an optical disk drive, and the like.

In an embodiment, the RF module 1030 receives a processed data signal from the processing circuitry 1010 and converts the data signal to beamforming wireless signals that are then transmitted via antenna arrays 1040, or vice versa. The RF module 1030 can include a digital to analog converter (DAC), an analog to digital converter (ADC), a frequency up converter, a frequency down converter, filters and amplifiers for reception and transmission operations. The RF module 1030 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 1040 can include one or more antenna arrays.

The apparatus 1000 can optionally include other components, such as input and output devices, additional or signal processing circuitry, and the like. Accordingly, the apparatus 1000 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
transmitting a physical sidelink control channel (PSCCH) including a 1st-stage sidelink control information (SCI) over a sidelink from a transmission user equipment (Tx UE) to a reception user equipment (Rx UE); and
transmitting a physical sidelink shared channel (PSSCH) that is associated with the PSCCH and multiplexed with a demodulation reference signal (DMRS),
wherein the 1st-stage SCI indicates a first PSSCH DMRS pattern of the DMRS multiplexed with the PSSCH.

2. The method of claim 1, further comprising:
receiving a configuration of one or more PSSCH DMRS patterns associated with a resource pool, wherein the 1st-stage SCI indicates one of the one or more PSSCH DMRS patterns as the first PSSCH DMRS pattern.

3. The method of claim 2, further comprising:
determining the first PSSCH DMRS pattern from the one or more PSSCH DMRS patterns based on feedback information on a channel condition of the sidelink and/or a preferred PSSCH DMRS pattern from the Rx UE.

4. The method of claim 1, further comprising:
transmitting a 2nd-stage SCI carried by a sequence-based signal.

5. The method of claim 1, further comprising:
transmitting a 2nd-stage SCI carried on the DMRS multiplexed with the PSSCH.

6. The method of claim 1, wherein the PSSCH includes channel state information (CSI) of a sidelink from the Rx UE to the Tx UE.

7. The method of claim 1, wherein the PSSCH includes a 2nd-stage SCI carrying CSI of a sidelink from the Rx UE to the Tx UE.

8. The method of claim 1, further comprising:
performing a channel busy ratio (CBR) measurement over resources defined by a resource pool, wherein resources for physical sidelink feedback channel (PSFCH) are excluded for the CBR measurement.

9. The method of claim 1, further comprising:
transmitting a sidelink primary synchronization signal (S-PSS) that is an M-sequence generated using a polynomial of x⁷+x⁴+1 and a cyclic shift of 22 or 65.

10. An apparatus, comprising circuitry configured to:
transmit a physical sidelink control channel (PSCCH) including a 1st-stage sidelink control information (SCI) over a sidelink from a transmission user equipment (Tx UE) to a reception user equipment (Rx UE); and
transmit a physical sidelink shared channel (PSSCH) that is associated with the PSCCH and multiplexed with a demodulation reference signal (DMRS),
wherein the 1st-stage SCI indicates a first PSSCH DMRS pattern of the DMRS multiplexed with the PSSCH.

11. The apparatus of claim 10, wherein the circuitry is further configured to:
receive a configuration of one or more PSSCH DMRS patterns associated with a resource pool, wherein the 1st-stage SCI indicates one of the one or more PSSCH DMRS patterns as the first PSSCH DMRS pattern.

12. The apparatus of claim 11, wherein the circuitry is further configured to:
determine the first PSSCH DMRS pattern from the one or more PSSCH DMRS patterns based on feedback information on a channel condition of the sidelink and/or a preferred PSSCH DMRS pattern from the Rx UE.

13. The apparatus of claim 10, wherein the circuitry is further configured to:
transmit a 2nd-stage SCI carried by a sequence-based signal.

14. The apparatus of claim 10, wherein the circuitry is further configured to:
transmit a 2nd-stage SCI carried on the DMRS multiplexed with the PSSCH.

15. The apparatus of claim 10, wherein the PSSCH includes channel state information (CSI) of a sidelink from the Rx UE to the Tx UE.

16. The apparatus of claim 10, wherein the PSSCH includes a 2nd-stage SCI carrying CSI of a sidelink from the Rx UE to the Tx UE.

17. The apparatus of claim 10, wherein the circuitry is further configured to:
perform a channel busy ratio (CBR) measurement over resources defined by a resource pool, wherein resources for physical sidelink feedback channel (PSFCH) are excluded for the CBR measurement.

18. The apparatus of claim 10, wherein the circuitry is further configured to:
transmit a sidelink primary synchronization signal (S-PSS) that is an M-sequence generated using a polynomial of x⁷+x⁴+1 and a cyclic shift of 22 or 65.

19. A non-transitory computer-readable medium storing instructions that, when executed by a processor, causing the processor to perform a method, the method comprising:
transmitting a physical sidelink control channel (PSCCH) including a 1st-stage sidelink control information (SCI) over a sidelink from a transmission user equipment (Tx UE) to a reception user equipment (Rx UE); and
transmitting a physical sidelink shared channel (PSSCH) that is associated with the PSCCH and multiplexed with a demodulation reference signal (DMRS),
wherein the 1st-stage SCI indicates a first PSSCH DMRS pattern of the DMRS multiplexed with the PSSCH.

20. The non-transitory computer-readable medium of claim 19, wherein the method further comprises:
receiving a configuration of one or more PSSCH DMRS patterns associated with a resource pool, wherein the 1st-stage SCI indicates one of the one or more PSSCH DMRS patterns as the first PSSCH DMRS pattern.
